(19) United States
(12) Patent Application Publication
(10) Pub. No.: US 2002/0081050 A1
(43) Pub. Date: Jun. 27, 2002

(54) Shaft bearing assembly

(76) Inventor: Herbert Cermak, Bessenbach (DE)

Correspondence Address: Robert P. Renke, Suite 250, 28333 Telegraph Road, Southfield, MI, 48034, US

(21) Appl. No.: 10/016,980

(22) Filed: Oct. 30, 2001

(30) Foreign Application Priority Data
Dec. 6, 2000 (DE) 100 60 481.1

(51) Int. Cl. F16C 27/00

(52) U.S. Cl. 384/536

(57) ABSTRACT

A resilient shaft bearing, suitable for use as an intermediate bearing for a propeller shaft of a motor vehicle is provided. The bearing includes an outer ring for securing to a carrying structure, an inner ring which serves to support the shaft, and a resilient annular element which is arranged between the outer ring and inner ring. The resilient annular element forms a circumferential channel structure which is filled with a dilatant liquid. The invention provides a bearing having damping characteristics proportional to the energy level of the vibration to be damped.

### TECHNICAL FIELD

The present invention relates to a shaft bearing, and more particularly concerns a resilient shaft bearing, suitable as an intermediate bearing for a propeller shaft of a motor vehicle.

### BACKGROUND OF THE INVENTION

Intermediate bearings for propeller shafts typically have an outer ring for securing to a carrying structure, an inner ring which serves to support the shaft, and a resilient annular element which is arranged between the outer ring and the inner ring. The inner ring is able to accommodate a bearing which can be fitted separately or it can be formed directly by the outer race of a rolling contact bearing where the rolling contact bearing has an inner race, rollers, and the outer race.

Shaft bearings of the foregoing type wherein the outer rings are directly and rigidly secured to the vehicle floor for the purpose of providing intermediate support for a propeller shaft are known. As a rule, constant velocity joints are arranged in the propeller shaft in the direct vicinity of the region where the intermediate support is provided. The resilient shaft bearings are radially resilient and to a certain extent also axially resilient. When using constant velocity joints in propeller shafts divided into two parts in this way, there may, under certain conditions, occur shaft vibrations in the range of the natural frequency of the intermediate bearing or other undesirable harmonics. Such vibrations can be avoided or reduced by changing the design of the entire system, or by providing absorbers or by damping the intermediate bearing, for example by using harder materials for the resilient annular element. However, the latter results in the propeller shaft being attached to the vehicle in a stiffer way, which leads to a deterioration in the NVH (noise-vibration-harshness) behavior.

It would therefore be desirable to provide an improved shaft bearing assembly which has a resilient shaft bearing as well as good NVH characteristics when secured to a vehicle.

### SUMMARY OF THE INVENTION

The present invention overcomes the drawbacks of prior systems through the provision of a resilient shaft bearing having effective damping for the resilient shaft bearing without, in principle, stiffening the intermediate bearing. In particular, a circumferentially annularly connected channel structure in the resilient annular element is provided. The channel structure is filled with a dilatant liquid. Dilatant liquids are liquids in which ever increasing shear stresses occur with an increasing shear speed, so that the flow resistance increases with an increasing speed of flow. In the resilient shaft bearing in accordance with the invention, radial resilient movements of the inner ring relative to the outer ring result in different changes in volume in the annularly connected channel structure, with the dilatant liquid having to flow back and forth together with the frequency of the vibrations. As a function of the speed of flow in the channel structure and with a predetermined amplitude, the dilatant behavior of the liquid results in an increased damping effect with an increasing frequency, but an increasing frequency accompanied simultaneously by a decreasing amplitude will not necessarily lead to an increase in the damping effect, because the influences on the speed of flow oppose each other. In an advantageous way, there is thus made available a softly dampened system which hardens with an increasing frequency and/or an increasing amplitude. The inventive shaft bearing therefore is an approximately energy-related self-controlling system in which the degree of damping, i.e. the extraction of energy from the system to be dampened, is increasing as the energy by which the system vibrates increases. Conversely, the degree of damping is decreasing when the energy level resulting in vibration of the system to be dampened decreases. There has thus been provided a system whose damping characteristics adjust themselves automatically as a function of the existing vibration energy.

According to a first embodiment, the annularly connected channel structure includes an annular channel with a constant cross-section. This embodiment is advantageous in that the design is simple. Nevertheless, in the case of a prevailing direction of vibrations, there occur periodic changes in volume in the channel structure. Such changes result in throttling effects in the displaced liquid and thus to the desired vibration damping effect.

According to a further embodiment, the channel structure includes individual chambers which are connected to one another by channels or conduits, with the individual conduits preferably having identical and constant cross-sections. The chambers and the conduits are preferably uniformly circumferentially distributed, and the chambers are arranged relative to a main direction of the vibrations in such a way to maximize possible changes in volume in two chambers positioned opposite one another in the main direction of the vibrations.

According to another embodiment, radially opposed conduits have identical cross-sections and, pairs of radially opposed conduits which are offset relative to one another by pitch angles, such as 90° or 60°, have different cross-sections with respect to one another. In this way, it is possible, for example, to provide a low damping effect in a main direction of the vibrations by relatively large conduits becoming effective, and to provide a higher damping effect in a second direction of vibrations extending perpendicularly relative to the main direction of the vibrations by narrower conduits becoming effective.

Four chambers and four conduits are provided or six chambers and six conduits, all uniformly circumferentially distributed.

Other advantages of the invention will become apparent upon reading the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

In the drawings:

FIG. 1 shows a first embodiment of an inventive shaft bearing in a longitudinal section through the bearing along line A-A of FIG. 2.

FIG. 2 shows an inventive shaft bearing according to FIG. 1 in an axial view of the bearing.

FIG. 3 shows a second embodiment of an inventive shaft bearing in a longitudinal section through the bearing along line B-B of FIG. 4.

FIG. 4 shows an inventive shaft bearing according to FIG. 3 in an axial view of the bearing.

FIG. 5 shows a third embodiment of an inventive shaft bearing in a longitudinal section through the bearing along line C-C of FIG. 6.

FIG. 6 shows an inventive shaft bearing according to FIG. 5 in an axial view of the bearing.

### DETAILED DESCRIPTION OF THE INVENTION

In the description that follows, the two Figures of each embodiment will be described jointly. Thus, to the extent the same parts are shown in the various views, they are given the same reference numerals. In one application of the invention, the shaft bearing is mounted at the vehicle floor in a position wherein it is turned by 180° around the longitudinal axis.

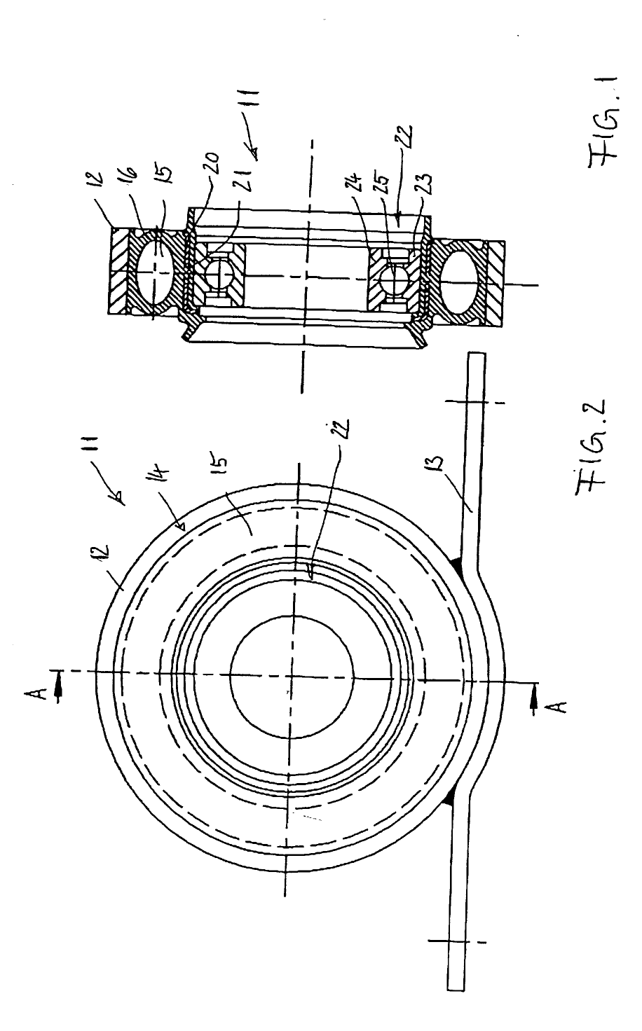

Referring now to FIGS. 1 and 2, a shaft bearing 11 includes an outer ring on to which there is welded a lug 13 for bolting purposes. Furthermore, the shaft bearing 12 includes a resilient annular element 14 and a rolling contact bearing 22. The resilient annular element consists of a continuous annular bead 16 for forming an annular channel 15 with a continuously uniform cross-section. For reinforcing purposes in the radial direction, a plate metal ring 20 with apertures 21 is vulcanised into the resilient annular element 14. A rolling contact bearing 22, having an outer bearing race 23, an inner bearing race 24 and bearing members 25, is directly inserted into the resilient annular element 14. The sealing means are not illustrated as these include any known method of sealing as understood in the art. The outer bearing race 23 simultaneously forms the inner ring of the shaft bearing 11. The annular channel 15 is completely filled with a dilatant liquid.

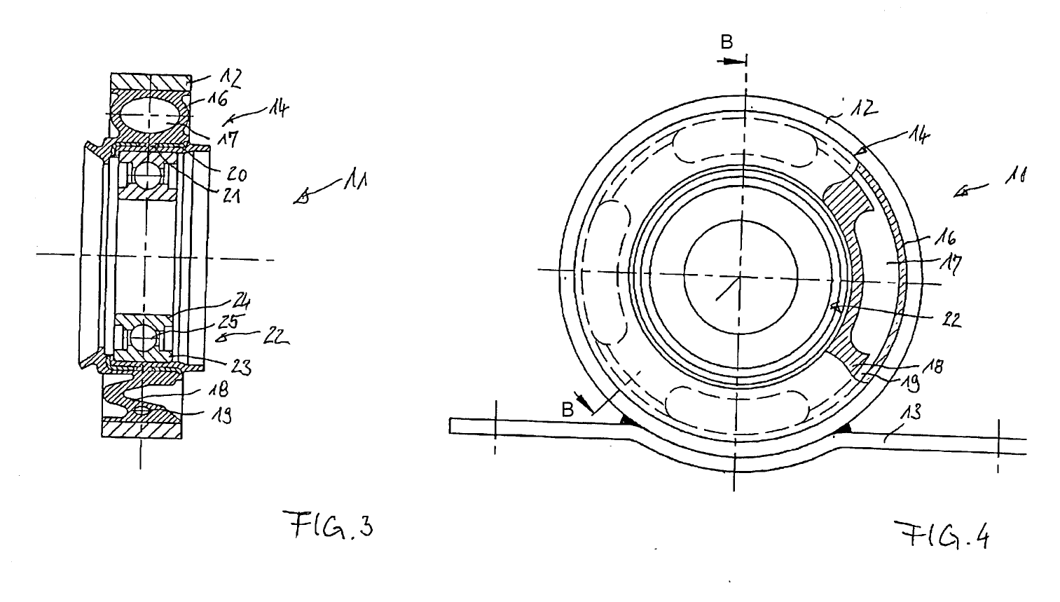

In FIGS. 3 and 4, the shaft bearing 11 includes an outer ring 12 on to which there is welded a lug 13 for bolting purposes. Furthermore, the shaft bearing 11 includes a resilient annular element 14 and a rolling contact bearing 22. The resilient annular element 14 includes an annular bead 16 for forming chambers 17 and an annular fold 18 in which there extend connecting channels or conduits 19. The individual chambers 17 (four chambers 17) are connected to one another and in the ring by circumferentially extending connecting conduits 19. For reinforcing purposes in the radial direction, a plate metal ring 20 with apertures 21 is vulcanised into the resilient annular element 14. A rolling contact bearing 22, having an outer bearing race 23, an inner bearing race 24 and bearing members 25, is directly inserted into the resilient annular element 14. Again, the sealing means are not shown in these Figures but include any known sealing means. The outer bearing ring 23 simultaneously forms the inner ring of the resilient shaft bearing 11 in accordance with the invention. The entire space formed by the chambers 17 and the conduits 19 is filled with a dilatant liquid. The chambers 17 are arranged in such a way that, if one assumes a vertical main direction of the vibrations (transversely to the fixing lug 13), the changes in volume in the chambers arranged vertically one above the other are greatest.

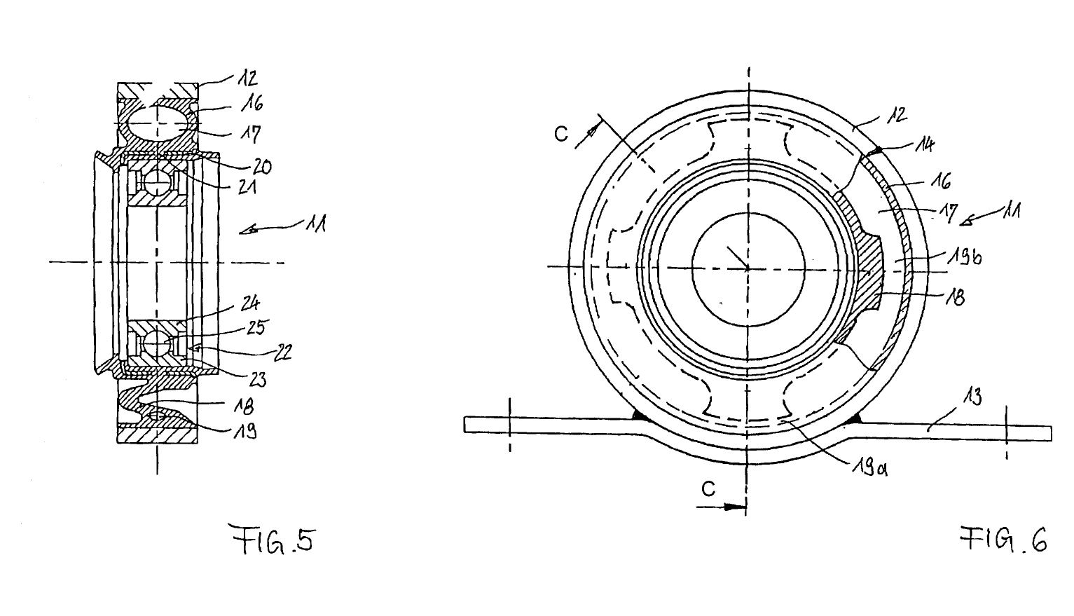

In FIGS. 5 and 6, a shaft bearing 12 includes an outer ring on to which there is welded a lug 13 for bolting purposes, as well as a resilient annular element 14 and a rolling contact bearing 22. The resilient annular element 14 includes an annular bead 16 for forming chambers 17 identical in size, and an annular fold 18 in which there extend connecting conduits 19a, 19b. The individual, chambers 17 (four chambers 17) are connected to one another and in the ring by circumferentially extending connecting conduits 19a, 19b. For reinforcing purposes in the radial direction, a plate metal ring 20 with apertures 21 is vulcanised into the resilient annular element 14. A rolling contact bearing 22, having an outer bearing race 23, an inner bearing race 24 and bearing members 25, is directly inserted into the resilient annular element 24. The structure includes sealing means (not illustrated). The outer bearing race 23 simultaneously forms the inner ring of the resilient shaft bearing 11 in accordance with the invention. The entire annular space formed by the chambers 17 and by the conduits 19a, 19b is filled with a dilatant liquid. The first conduits 19a arranged opposite one another in pairs have a smaller cross-section, and thus a greater throttling effect, than the second conduits 19b arranged opposite one another in pairs. The chambers 17 are arranged in such a way that, if one assumes a vertical main direction of the vibrations (transversely to the fixing lug), the displacement of liquid occurs through the conduits 19b with the greater cross-section, with the damping effect thus being less pronounced; whereas if the direction of the vibrations is perpendicular thereto, the displacement of liquid occurs through the narrower conduits 19a, which results in a greater damping effect. If the vibrations comprise components in both directions, the respective effects are superimposed on one another.

From the foregoing it can be seen that there has been brought to the art a new and improved resilient shaft bearing assembly having automatically adjustable damping characteristics as a function of the vibration energy level. While the invention has been described in connection with one or more embodiments, it should be understood that the invention is not limited to those embodiments. For example, the chambers 17 can be non-uniform in size as well as the conduits. Thus, at least two of the chambers 17 can have different volumes, or opposing pairs of chambers 17 and can be of a different size than adjacent opposing pairs of chambers. Thus, the invention covers all alternatives, modifications, and equivalents as may be included in the spirit and scope of the appended claims.

What is claimed is:

1. A resilient shaft bearing comprising an outer ring for securing to a carrying structure, an inner ring for supporting a shaft, and a resilient annular element arranged between the outer ring and the inner ring and defining a circumferential channel structure said channel structure being filled with a dilatant liquid.

2. A resilient shaft bearing according to claim 1, wherein the channel structure comprises an annular channel with a substantially constant cross-section.

3. A resilient shaft bearing according to claim 1, wherein the channel structure comprises a plurality of chambers which are connected to one another by conduits.

4. A resilient shaft bearing according to claim 3, wherein each conduit has substantially the same cross-section and a substantially constant cross-section.

5. A resilient shaft bearing according to claim 3, wherein radially opposed conduits have substantially identical cross-sections and wherein pairs of radially opposed conduits which are offset relative to other pairs of radially opposed conduits have different cross-sections with respect to one another.

6. A resilient shaft bearing according to claim 5, wherein said pairs of radially opposed conduits are offset relative to adjacent pairs of radially opposed conduits by 60°.

7. A resilient shaft bearing according to claim 5, wherein said pairs of radially opposed conduits are offset relative to adjacent pairs of radially opposed conduits by 90°.

8. A resilient shaft bearing according to claim 3 comprising four chambers and four conduits which are uniformly circumferentially distributed.

9. A resilient shaft bearing according to claim 4 comprising four chambers and four conduits which are uniformly circumferentially distributed.

10. A resilient shaft bearing according to claim 3 comprising six chambers and six conduits which are uniformly circumferentially distributed.

11. A resilient shaft bearing according to claim 4 comprising six chambers and six conduits which are uniformly circumferentially distributed.

12. A resilient shaft bearing according to claim 1 comprising fixing lugs formed at the outer ring.

13. A resilient shaft bearing according to claim 1, wherein the inner ring is formed by an outer race of a rolling contact bearing.

14. A resilient shaft bearing according to claim 3, wherein at least two of said plurality of chambers define different size volumes.
